(19) United States
(12) Patent Application Publication
(10) Pub. No.: US 2016/0230964 A1
(43) Pub. Date: Aug. 11, 2016

(54) APPARATUS, METHOD, AND SYSTEM FOR HIGHLY CONTROLLED LIGHT DISTRIBUTION USING MULTIPLE LIGHT SOURCES

(71) Applicant: Musco Corporation, Oskaloosa, IA (US)

(72) Inventors: Lawrence H. Boxler, Columbus, IN (US); Chris P. Lickiss, Newton, IA (US); Luke C. McKee, Oskaloosa, IA (US)

(21) Appl. No.: 14/615,092

(22) Filed: Feb. 5, 2015

(51) Int. Cl. F21V 17/00; F21V 17/06; F21V 7/00; F21V 21/30; F21V 17/02

(52) U.S. Cl. CPC F21V 17/002; F21V 21/30; F21V 17/02; F21V 7/0066; F21V 17/06; F21Y 2105/001

(57) ABSTRACT

Disclosed herein are apparatus, method, and system for producing a customizable composite beam from a plurality of solid state light sources. Each light source is associated with individually adjustable fixture components which allow for a variety of lighting needs to be addressed. The composite beam is a collective of the beam projected from each adjustable component/light source combination; each individual beam being of customized shape or standard shape.

### CROSS-REFERENCE TO RELATED APPLICATIONS

This application is a continuation of co-pending U.S. Ser. No. 13/659,515 filed Oct. 24, 2012, which application is a continuation of co-pending U.S. Ser. No. 12/751,519 filed Mar. 31, 2010, now Pat. No. 8,449,144 issued on May 28, 2013, which is a continuation-in-part of co-pending PCT application No. PCT/US09/57090 filed Sep. 16, 2009, and co-pending U.S. Ser. No. 12/467,160 filed May 15, 2009, now Pat. No. 8,356,916 issued on Jan. 22, 2013, both of which claim priority to provisional U.S. Ser. No. 61/097,483 filed Sep. 16, 2008 and U.S. Ser. No. 61/054,089 filed May 16, 2008, all of which are hereby incorporated by reference in their entirety.

### BACKGROUND OF THE INVENTION

The present invention generally relates to systems and methods for lighting. More specifically, the present invention relates to an adjustable lighting fixture utilizing light emitting diodes (LEDs) to produce highly controlled and highly customized lighting.

In the current state of the art, the light projected from a fixture is often characterized in terms of the pattern of light as viewed on a target area; this is often referred to as the beam distribution type, beam type, or beam pattern. Beam distribution types are well known in the state of the art and are well defined and standardized by various organizations (e.g., the Illuminating Engineering Society (IES)).

Various light source types (e.g., HID, LED) can produce a given beam type via use of optical elements (e.g., reflective or refractive lenses). With LEDs, for example, a fixture may comprise a plurality of LED light sources, each light source coupled with an optic such that the composite beam (i.e., the collective of each beam projected from each LED) is of a particular beam distribution type. One example of this in the current state of the art are THE EDGE™ fixtures—available from Beta Lighting Inc., Sturtevant, Wis., U.S.—which use an array of identical NANOOPTIC™ refractors to produce a specific beam distribution type.

One disadvantage to such current art approaches is that the designed optics are only useful in producing a single beam type; they must be modified or replaced if a different beam type is desired. In the case of LEDs, this can require the modification or replacement of dozens of optics. Additionally, such fixtures afford little flexibility; a type II beam pattern (as defined by IES) may be sufficient to illuminate a target area but if the target area changes (e.g., the area to be illuminated is increased, the target area is moved), or the lighting needs change (e.g., spill light needs to be eliminated, glare needs to be controlled), the beam type may no longer be appropriate for the application. Of course, the fixture itself may be adjusted about a particular axis to positionally shift the projected light, but this will not significantly change the beam type.

The current state of the art may benefit from improved design of lighting fixtures such that projected light from said fixtures may be customized to produce beam patterns beyond those which are well defined and standardized in the industry. Further, the art may benefit if the components of lighting fixtures may be made modular such that components may be switched in and out onsite to facilitate fast, easy, and cost-effective customization of a projected beam type. Thus, there is room for improvement in the art.

### I. SUMMARY OF THE INVENTION

Envisioned are apparatus, method, and system for lighting fixtures which comprise adjustable components to facilitate customization in lighting a target area in a manner that allows greater control over light distribution and light intensity than in some fixtures in the current state of the art. Embodiments of the present invention are described with reference to LEDs and LED lighting, however, embodiments of the present invention are equally applicable to other solid state light sources, other lighting devices (e.g., lasers), or other fixtures that allow for multiple light sources to be packaged together in a small area.

It is therefore a principle object, feature, advantage, or aspect of the present invention to improve over the state of the art and/or solve problems and deficiencies in the state of the art.

Further objects, features, advantages, or aspects of the present invention may include one or more of the following:

a. producing a composite beam which may include standard beam distribution types and/or customized beam types;

b. producing a composite beam from a plurality of individual beams, each individual beam being produced from a selection of a relatively small number of fixture components;

c. locating fixture components relative to the light source in a manner that maintains tight control over light distribution; and

d. developing a fixture in which fixture components may be aimed prior to installation but may also be aimed, adjusted, or switched with other fixture components onsite after installation.

One aspect of the invention comprises an apparatus including a plurality of solid state light sources, positioning rings, and optical components.

Another aspect of the invention comprises a method of designing an optic system including one or more of: (a) a light distributing member and (b) a light blocking member. Another aspect according to the invention is illustrated in FIG. 1A in which a composite beam 200, which may be produced by the apparatus or method described above, is formed from individual light beams 210 from a single fixture 10; note only a few light beams 210 are illustrated in FIG. 1A and are not representative of the number of light beams produced from fixture 10. Alternatively, as illustrated in FIG. 1B, a composite beam 220 may be formed from individual light beams 210 from multiple fixtures 10 which may be affixed to a single pole 11; again, for purposes of demonstration and brevity, only a few beams 210 are illustrated.

These and other objects, features, advantages, or aspects of the present invention will become more apparent with reference to the accompanying specification.

### II. BRIEF DESCRIPTION OF THE DRAWINGS

From time-to-time in this description reference will be taken to the drawings which are identified by figure number and are summarized below.

FIGS. 1A and 1B illustrate the creation of a composite beam from a plurality of individual beams according to one aspect of the present invention.

FIG. 2 illustrates one possible lighting fixture according to at least one aspect of the present invention.

FIG. 3A illustrates a perspective view of a subassembly which is housed in the lighting fixture of FIG. 2.

FIG. 3B illustrates, in exploded form, the components of the subassembly of FIG. 3A.

FIG. 3C illustrates, in exploded perspective view, details of some of the components of the subassembly of FIG. 3A.

FIGS. 4A-D illustrate various views of the locating ring according to at least one aspect of the present invention.

FIGS. 5A-E illustrate various views of the reflector according to at least one aspect of the present invention.

FIGS. 6A-D illustrates various views of the visor base according to at least one aspect of the present invention.

FIG. 7 illustrates a top view (with respect to FIG. 3A) of the circuit board according to at least one aspect of the present invention.

FIG. 8 illustrates a top view (with respect to FIG. 3A) of the retaining plate according to at least one aspect of the present invention.

FIGS. 9A and 9B illustrate photometric data for an LED with a standard parabolic reflector. FIG. 9A illustrates an isocandela diagram and FIG. 9B illustrates a footcandle diagram.

FIGS. 9C and 9D illustrate photometric data for an LED with a modified reflector. FIG. 9C illustrates an isocandela diagram and FIG. 9D illustrates a footcandle diagram.

FIGS. 9E and 9F illustrate photometric data for an LED with an alternative modified reflector. FIG. 9E illustrates an isocandela diagram and FIG. 9F illustrates a footcandle diagram.

### III. DETAILED DESCRIPTION OF EXEMPLARY EMBODIMENTS

A. Overview

To further understanding of the present invention, a specific exemplary embodiment according to the present invention will be described in detail. Frequent mention will be made in this description to the drawings. Reference numbers will be used to indicate certain parts in the drawings. The same reference numbers will be used to indicate the same parts throughout the drawings.

Aspects according to the present invention provide for a lighting fixture—using LEDs or other solid state light sources—which projects a composite beam that is customizable and adjustable; customizable in that a desired beam distribution pattern (which may or may not be a standard beam pattern per the lighting industry) may be effectuated from a relatively small number of fixture components, and adjustable in that components may be traded out onsite if lighting effect changes (e.g., glare control, spill light control) are desirable.

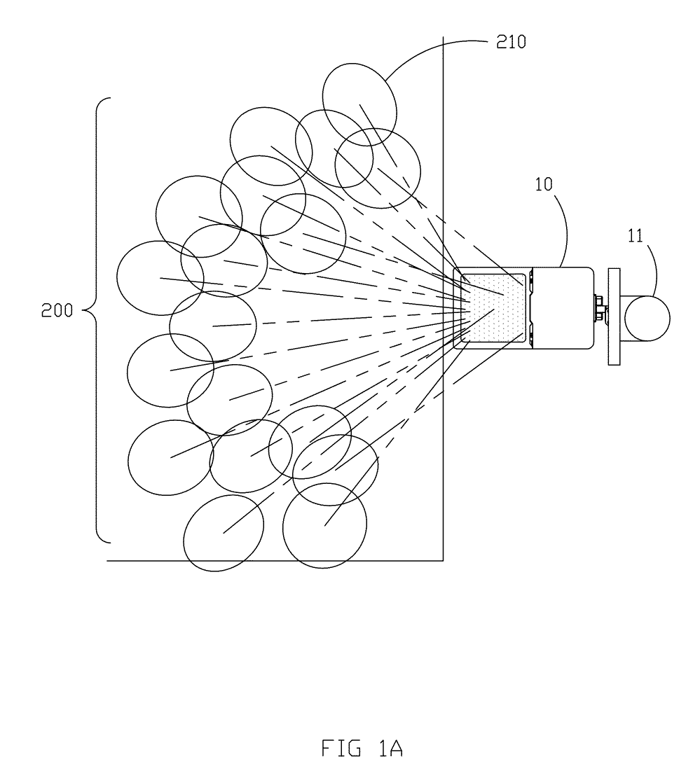

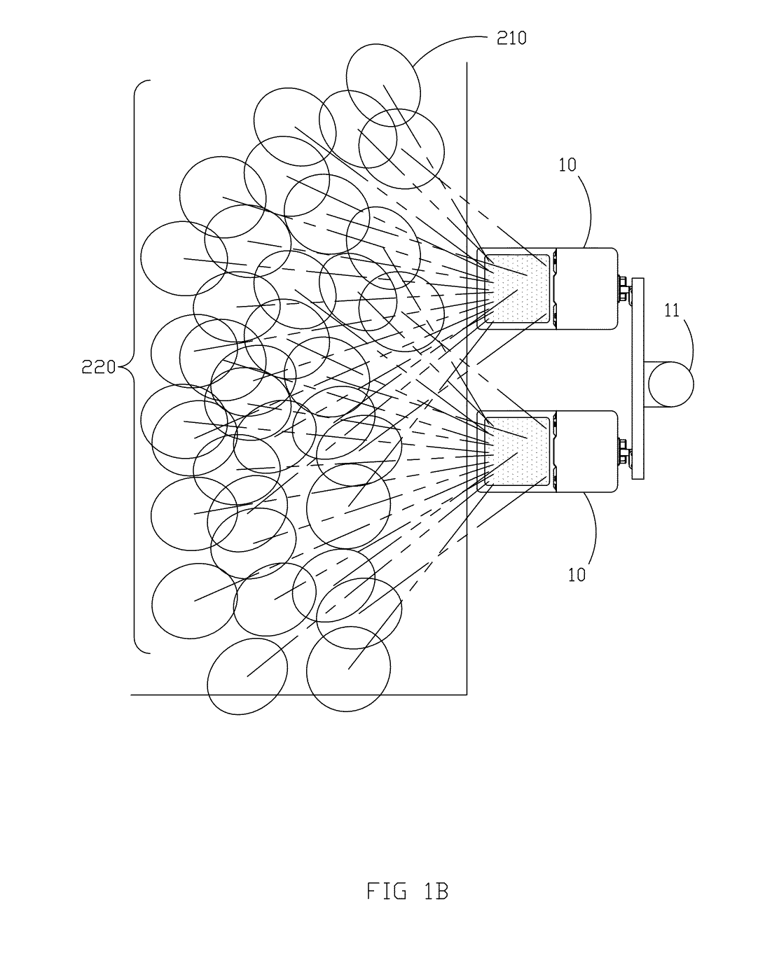

As has been stated, the projected composite beam may be comprised of light emitted from a plurality of light sources in a single fixture (see FIG. 1A) or a plurality of fixtures (see FIG. 1B); likewise, the composite beam may include light projected from multiple light sources that are housed on multiple poles (see reference no. 11). It is of further note, that as described in aforementioned PCT application No. PCT/US09/57090, U.S. application Ser. No. 12/467,160, and U.S. provisional application No. 61/097,483, the composite beam may comprise overlapped individual beams similar in shape (e.g., to obtain a desired illumination), overlapped or juxtaposed individual beams different in shape (e.g., to obtain a desired beam shape), or some combination thereof to address lighting needs. In essence, the composite beam may comprise any number of individual beams each of which may be adjustable in terms of shape, size, intensity, aiming and/or orientation relative to the fixture, or otherwise. Specific methods of designing such composite beams are discussed in the aforementioned parent patent applications, which are incorporated by reference in their entirety.

B. Exemplary Method and Apparatus Embodiment I

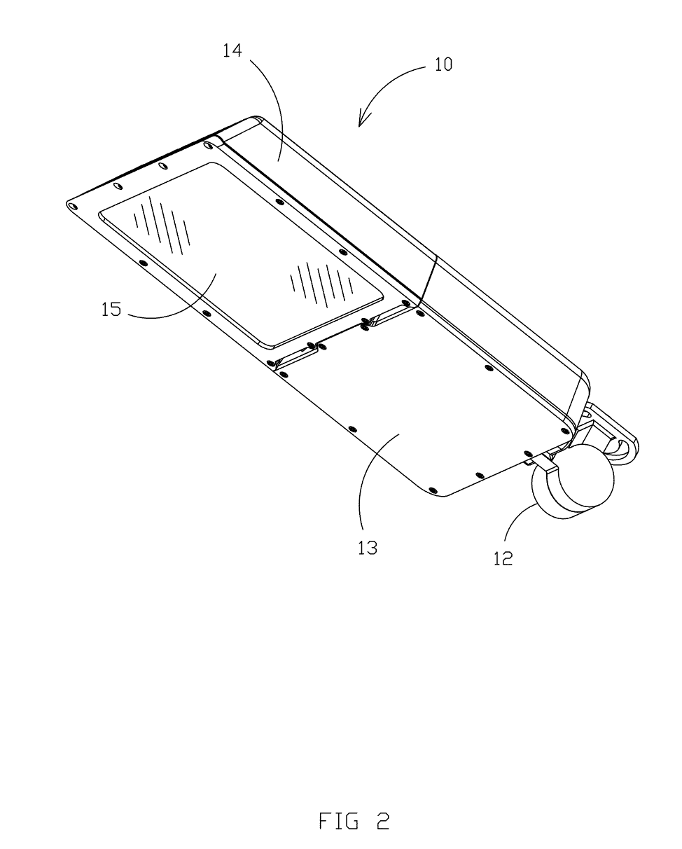

A more specific exemplary embodiment, utilizing aspects of the generalized example described above, will now be described. FIG. 2 illustrates one possible lighting fixture 10 which houses multiple LEDs and comprises an aluminum housing 14, a removable panel 13 for access to the power regulating devices associated with the LEDs (which are well known in the art of lighting), a removable lens 15 for access to the LEDs and associated optics, and an adjustable mounting knuckle 12 for mounting lighting fixture 10 to a pole 11 or other structure. As described in the incorporated-by-reference parent patent applications, lens 15 may further comprise an anti-reflective coating which, as is well known in the art of lighting, may allow for a variety of angles of incidence up from normal.

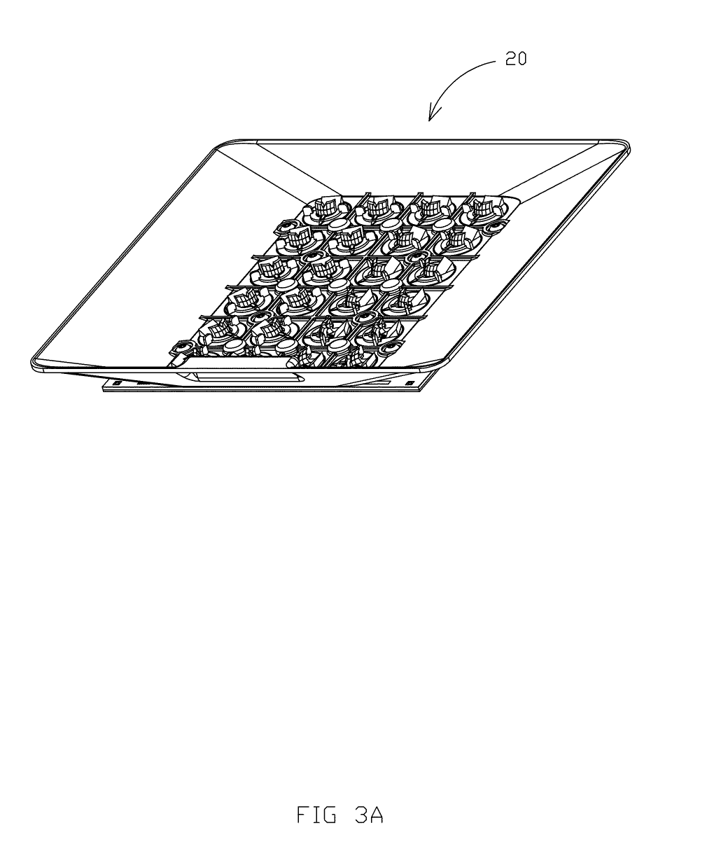

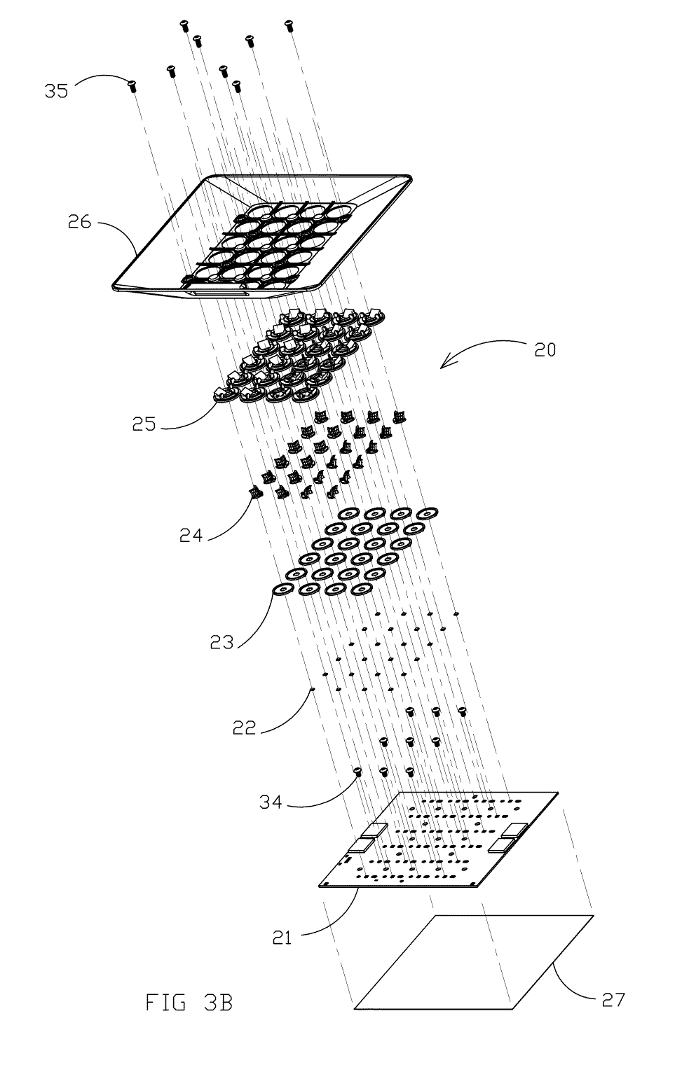

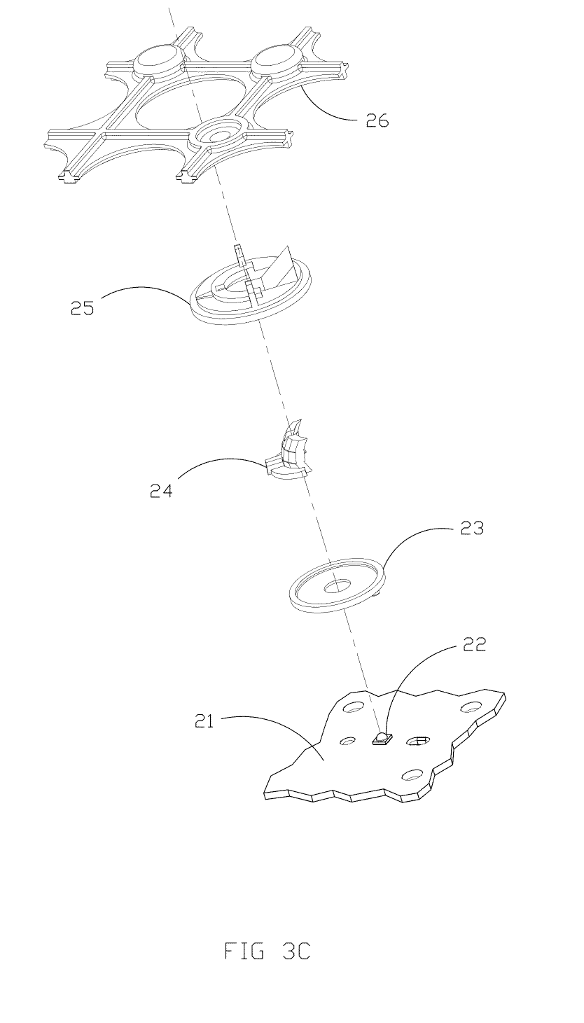

FIGS. 3A-C illustrate a subassembly 20 housed in fixture 10 which comprises a thermal interface layer 27, LED circuit board 21, LEDs 22, locating ring 23, reflector 24, visor base 25, and retaining plate 26. As illustrated, subassembly 20 houses twenty-four LEDs with assorted components; however this is by way of example and not by way of limitation.

Thermal interface layer 27 may be of any available type; the primary purpose of layer 27 is to fill the space between circuit board 21 and housing 14 to facilitate heat dissipation; housing 14 acts as a heat sink for LEDs 22. LEDs 22 can be model XP-G available from Cree, Inc., Durham, N.C., USA, though this is by way of example and not by way of limitation.

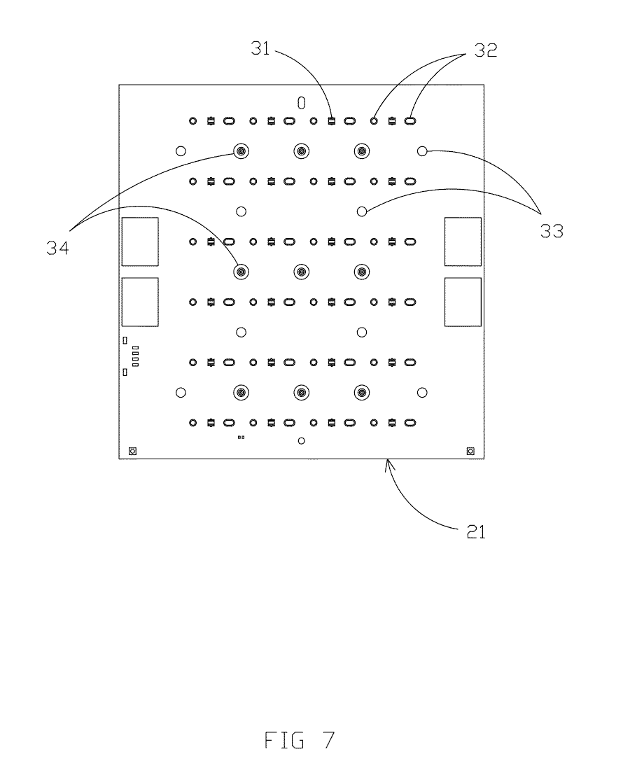

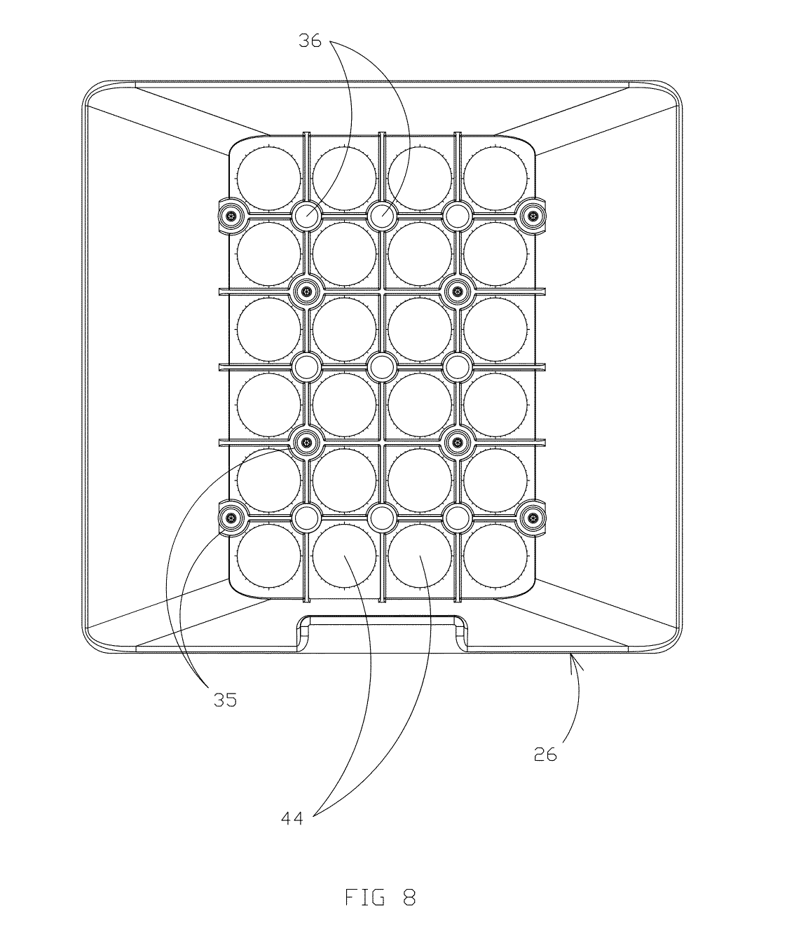

A detailed view of circuit board 21 is illustrated in FIG. 7. As can be seen, LED board 21 comprises positioning points 31 for LEDs 22 and a pair of apertures 32 for positioning locating rings 23 about position points 31 (and, therefore, LEDs 22). With further respect to FIG. 7, LED circuit board 21 comprises bolts 34 (or analogous components) which affix board to housing 14. Apertures 33 are adapted to receive bolts (or analogous components) extending through retaining plate 26, which is illustrated in FIG. 8. As can be seen from FIG. 8, formed portions 36 of retaining plate 26 are shaped to accommodate the bolt heads of bolts 34 in circuit board 21. Bolts 35 through retaining plate 26 extend through apertures 33 and affix retaining plate 26 and circuit board 21 to housing 14.

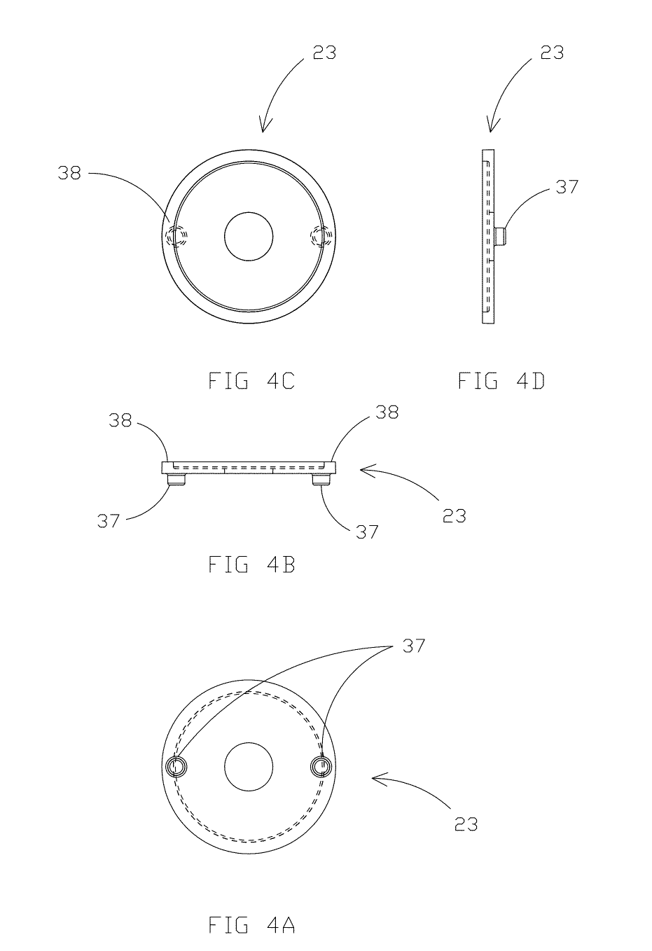

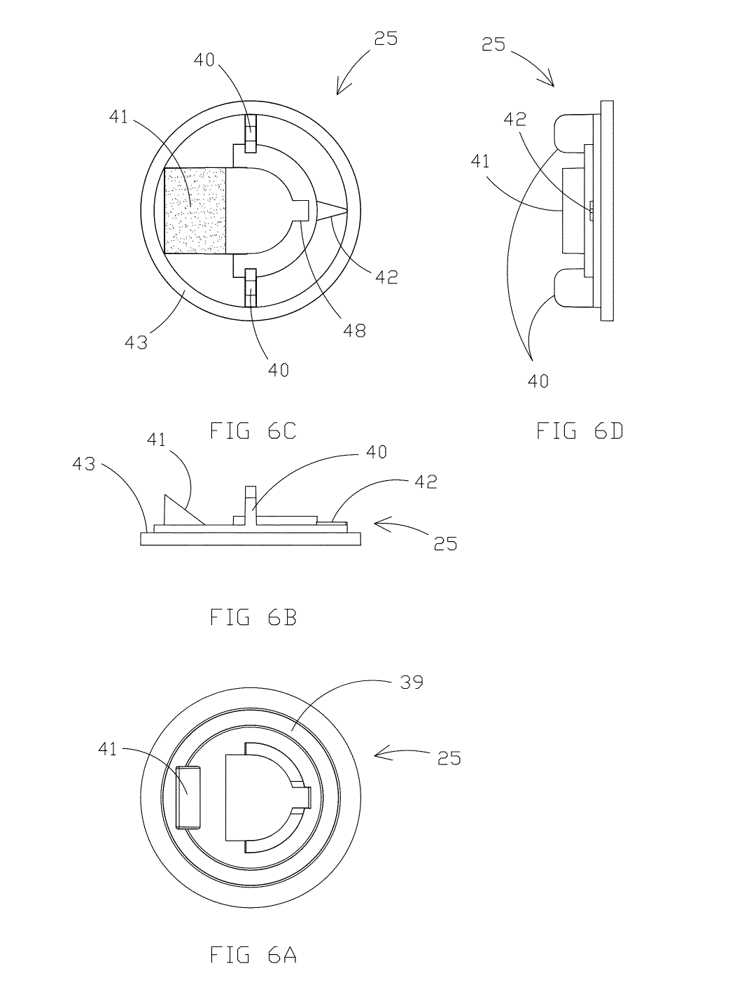

FIGS. 4A-D illustrate locating ring 23 in more detail; as can be seen, pegs 37 are adapted to fit in apertures 32 of LED circuit board 21. Ridge 38 of locating ring 23 is adapted to fit in channel 39 of visor base 25 (see FIG. 6A). When ridge 38 is seated in channel 39, reflector 24 is positionally affixed in visor base 25 and pivotable relative to LED 22 (see FIGS. 3B and 3C). The use of locating ring 23 is an improvement over the current state of the art because it helps to maintain alignment of reflector 24 relative to LEDs 22 which, according to one estimate, is required to be on the order of ±0.02″ to maintain adequate control of light distribution. For example, according to one method in the current state of the art a large plate with pre-punched apertures is laid over optical elements (similar to reflector 24) so to both align and positionally affix said optical elements. While functional, such plates must maintain tolerancing relative to each LED across the length of the entire part, which may be on the order of one foot or more. Alternatively, locating ring 23 is on the order of one inch in diameter and since there is a locating ring associated with each LED 22, strict tolerancing for each LED is more readily attained.

With regards to FIGS. 6A-D, visor base 25 further comprises grip tabs 40, visor 41, alignment marker 42, and ridge 43. As envisioned, visor base 25 is of polymeric composition with visor 41 metallized to act as a reflecting surface for light emitted from LED 22. Visor base 25 is adapted such that ridge 43 is compressed under retaining plate 26 with grip tabs 40, visor 41, and alignment marker 42 projecting through aperture 44 of plate 26; see FIG. 3A. As envisioned, visor 41 projects 37° upward from horizontal (i.e., the plane of retaining plate 26), though other angles, sizes, and shapes of visor 41 are possible and envisioned.

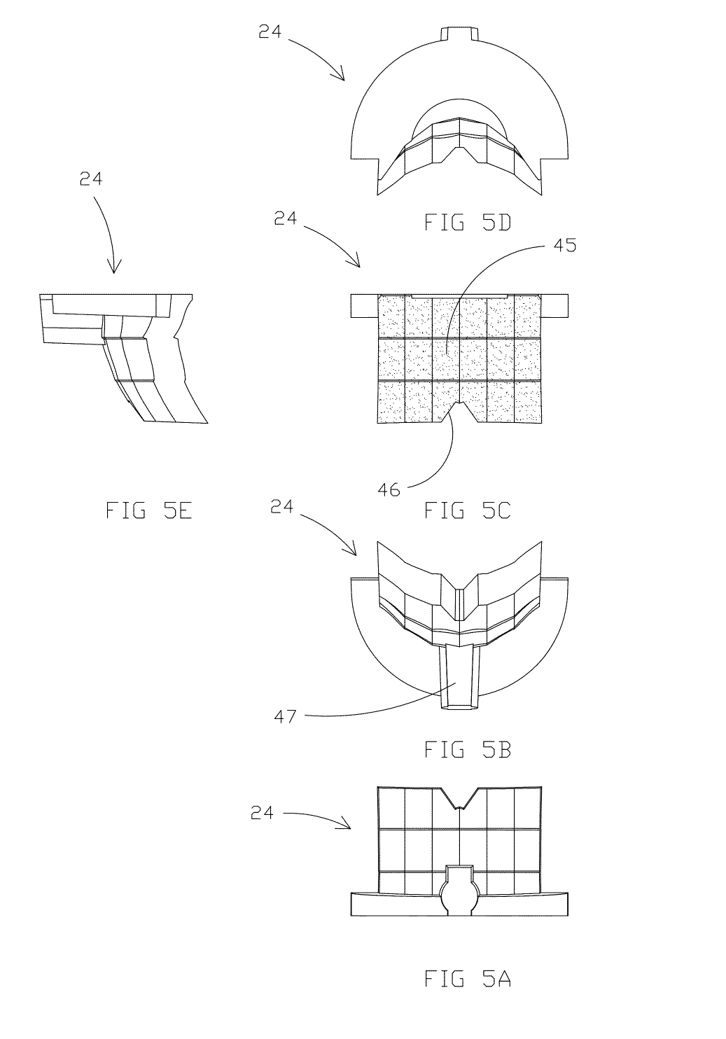

FIGS. 5A-E illustrate reflector 24 in more detail; as can be seen, reflector includes facets 45 which are metallized on the inner surface to aid in reflecting and a notch 46 to provide downward lighting. Tab 47 of reflector 24 is adapted to fit in notch 48 of visor base 25 such that, when ridge 38 of locating ring 23 is seated in channel 39 of visor base 25, metallized surfaces on visor 41 and reflector 24 are facing each other, are fixed relative to each other, surround LED 22, and may pivot 360° about LED 22. As envisioned, reflector 24 is a modified parabolic design produced by methods described in the incorporated-by-reference parent patent applications; however, this is by way of example and not by way of limitation. Other reflector designs are possible, and envisioned. For example, a reflector designed to allow for downlighting may be used in some subassemblies 20 of fixture 10 while other subassemblies 20 in the same fixture 10 use reflector 24; this combination of reflector designs allows adjustability of any portion or all of the composite beam in both the horizontal and vertical axes.

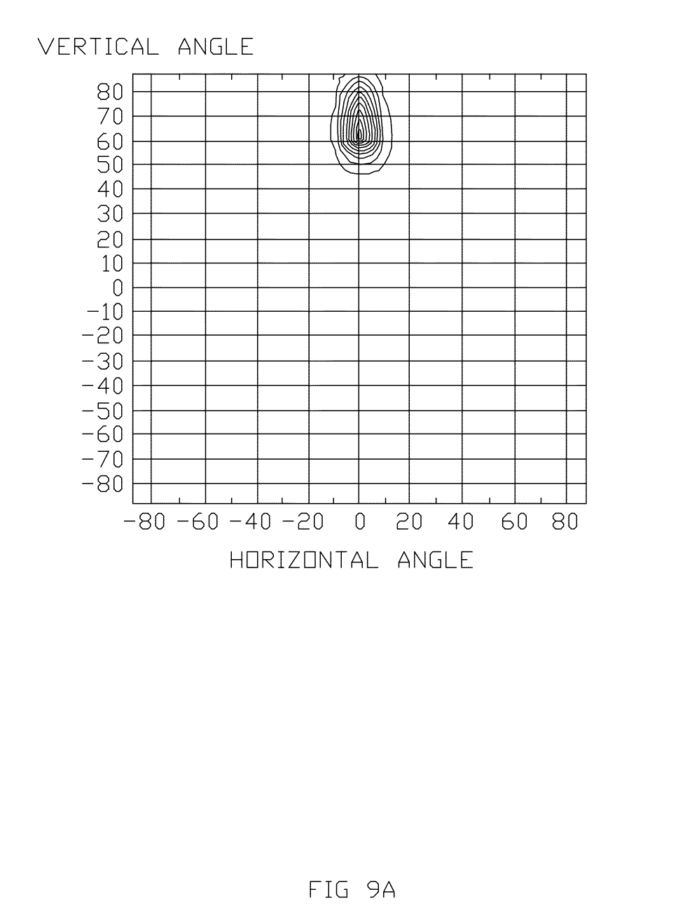

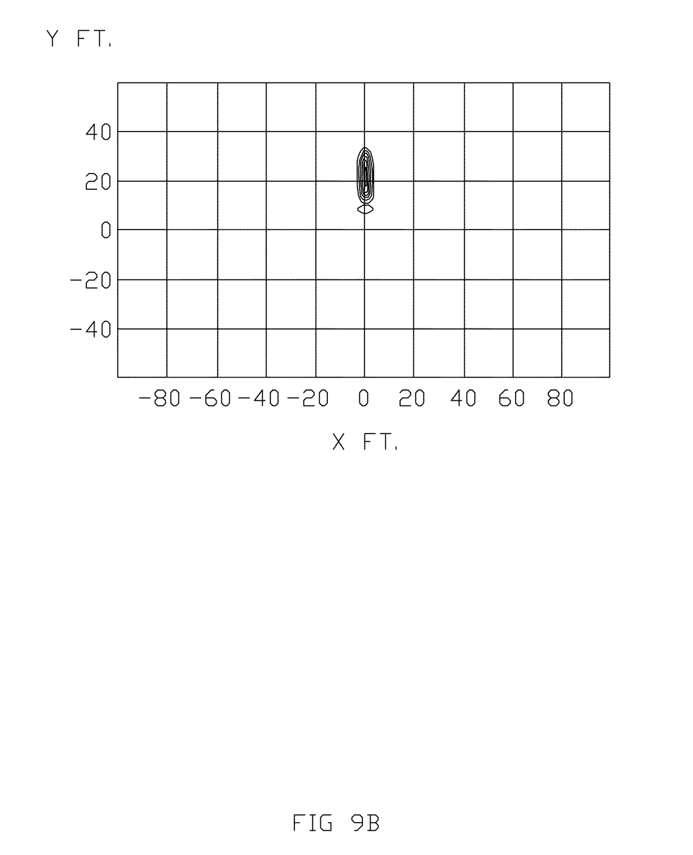

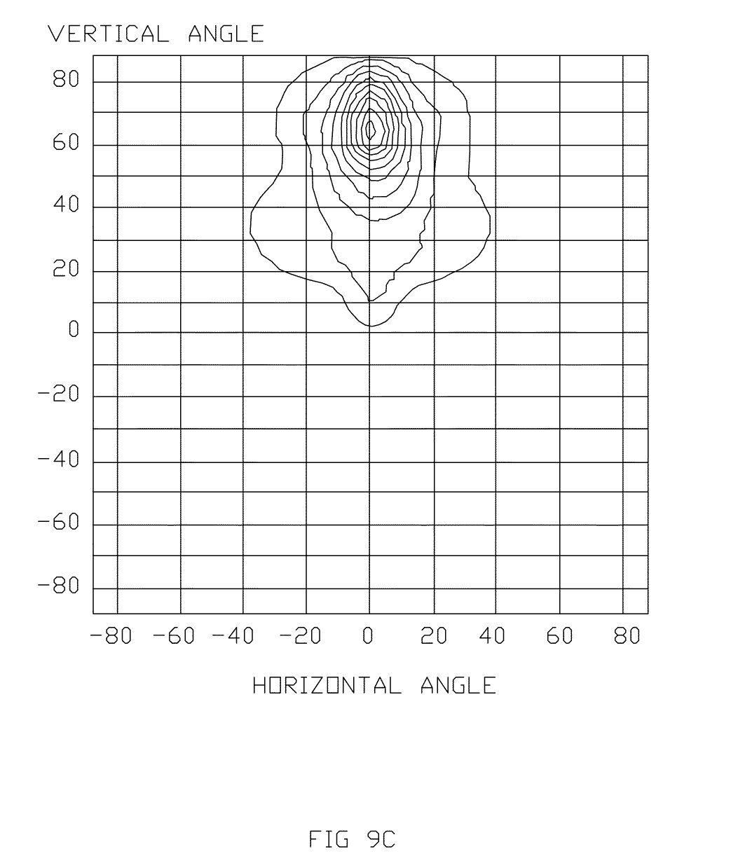

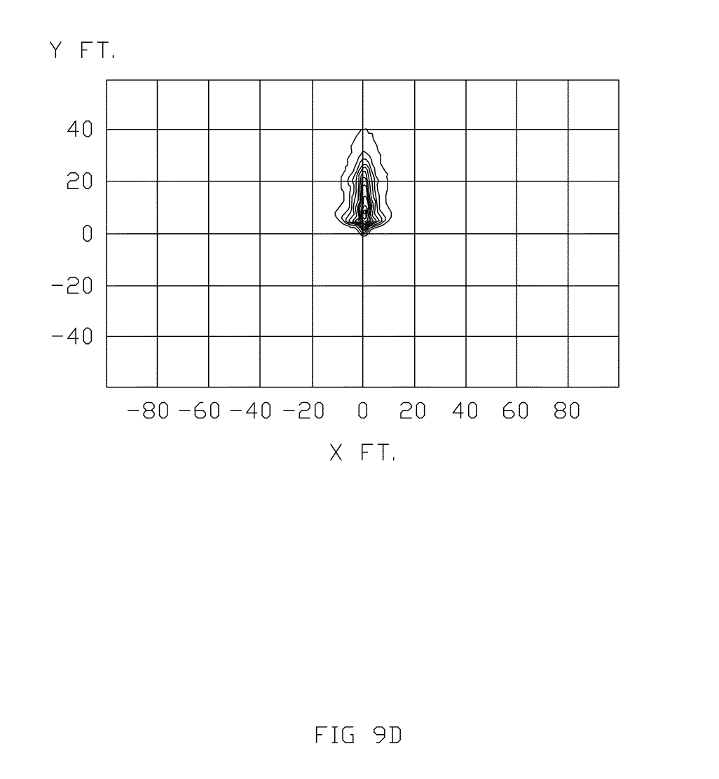

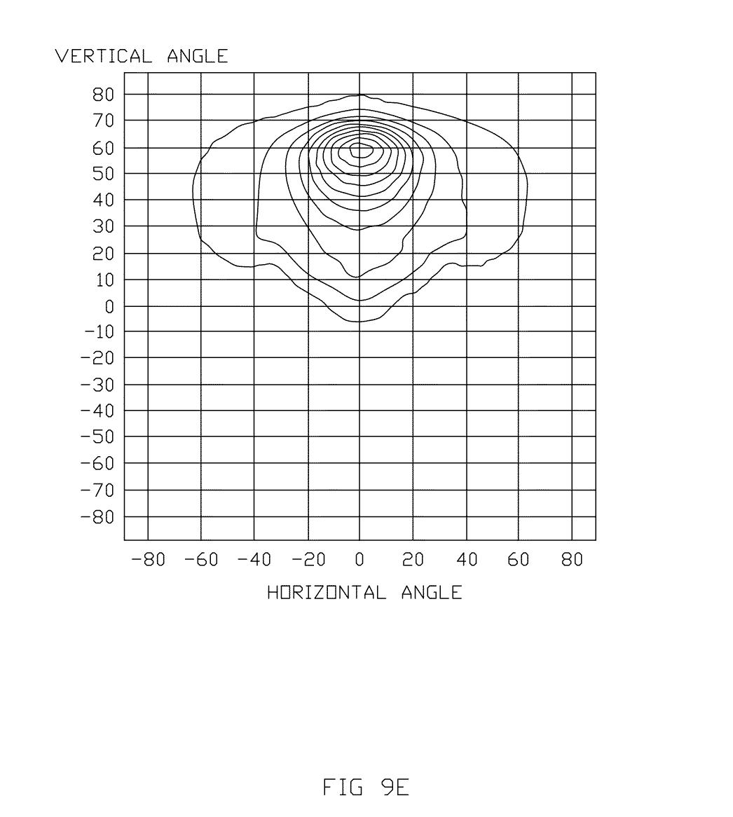

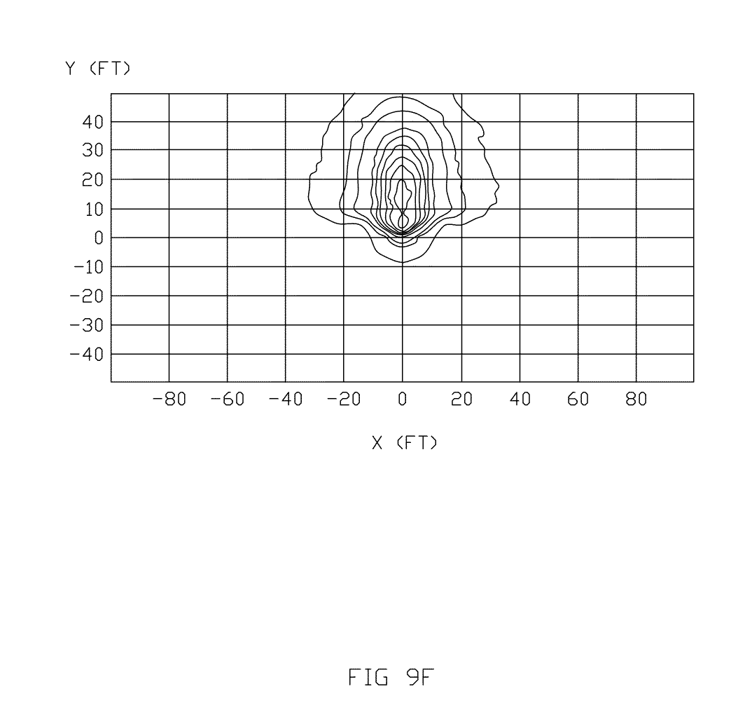

However, the design of reflector 24 offers some benefits over previous designs; namely, the ability to create a larger, more even beam pattern that is better suited to overlapping to build a composite beam. For example, FIGS. 9A and B illustrate isocandela and footcandle diagrams, respectively, for a standard parabolic reflector 10′ above the target area using a Cree XR-E LED; it of note that aiming is 70° to nadir to allow for a more direct comparison to FIGS. 9C-F. FIGS. 9C and 9D illustrate isocandela and footcandle diagrams, respectively, for the modified parabolic reflector disclosed in the parent patent applications 10′ above the target area using a Cree XR-E LED. FIGS. 9E and 9F illustrate isocandela and footcandle diagrams, respectively, for reflector 24 at 10′ above the target area using a Cree XP-G LED. Comparing diagrams for the three reflector designs illustrates the progression from a spot-type beam where light transitions abruptly from intense light to no light, to a spread-type beam where projected light transitions gradually across the enlarged lighted area.

According to one possible method, a lighting designer or other person(s) determines the lighting needs (e.g., size, desired illumination level) of a particular area and determines which fixture components are suitable for the application (e.g., different shapes of reflector 24 may be available, different color or size of LEDs 22 may be available). Circuit board 21 is secured to housing 14 via bolts 34, thermal interface layer 27 filling the space between the bottom of circuit board 21 and the inner surface of housing 14. LEDs 22 are then placed at positioning points 31 on the secured board and the necessary electrical connections made. Locating rings 23 are then placed about LEDs 22 by placing pegs 37 of rings 23 in apertures 32 of secured circuit board 21. Reflectors 24 are placed in the center aperture of visor bases 25 by securing tabs 47 of reflectors 24 in cutouts 48 of visor bases 25. Reflector/visor bases 24/25 are then placed on locating rings 23 by securing ridges 38 of locating rings 23 in channels 39 of visor bases 25.

Optical elements are placed in their correct orientation by pivoting visor base/reflector 25/24 about LEDs 22 by grip tabs 40; grip tabs 40 are beneficial to the design because they allow one to pivot visor base/reflector 25/24 about LEDs 22 without touching (and possibly diminishing the effectiveness of) metallized surfaces or damaging parts. Initial orientation of fixture components may be determined according to methods described in the incorporated-by-reference parent patent applications or otherwise.

Once all optical elements are oriented, indexed, or otherwise aimed, retaining plate 26 is lowered into housing 14, centered about optical elements, and bolts 35 are tightened (as stated, bolts 35 pass through apertures 33 in secured circuit board 21 before being secured to housing 14, helping to ensure alignment of the fixture components relative to each other and relative to housing 14). Remaining electrical connections are made, lens 15 is affixed to fixture 10, fixture 10 is mounted to pole 11 and powered, and fixture 10 is aligned via mounting knuckle 12. If at some point lighting needs change, fixture components fail or become damaged, or otherwise, aiming of fixture components may be changed by loosening bolts 35 and pivoting visor bases/reflectors 25/24 via grip tabs 40; alternatively or in addition, visor bases 25 and/or reflectors 24 may be switched out. If optical elements are realigned, the change can be quantified by the change in position of alignment marker 42 of visor base 25 relative to degree markings on plate 26 (see FIG. 8).

C. Options and Alternatives

The invention may take many forms and embodiments. The foregoing examples are but a few of those. To give some sense of some options and alternatives, a few examples are given below.

It is of note that LEDs 22 may differ from those described herein in a number of ways and not depart from at least some aspects of the present invention. For example, other models of LEDs, or other solid state sources, may be used. As another example, subassembly 20 may include more or fewer LEDs than illustrated. As another example, LEDs 22 may be placed in an offset pattern on circuit board 21. As another example, colored LEDs may be used. Likewise, reflector 24 and visor 41 may differ from those described herein. For example, reflector 24 may be larger or smaller or may have notch 46 omitted from the design; as has been stated, a combination of reflector designs may be used in the same fixture. As another example, visor 41 may be steeper or more shallow than illustrated.

As another example, fixture components may differ in composition. For example, rather than formed polymer with surfaces that are metallized, visor 41 and reflector 24 may comprise formed and polished aluminum.

It is of note that, as previously stated, a composite beam may comprise any number of individual beams each of which may be adjustable in terms of shape, size, intensity, aiming and/or orientation relative to the fixture, or otherwise. Further, any combination of various types and designs of optical elements (i.e., LED, visor, and reflector) may be used in subassembly 20 to achieve a desired composite beam.

As another option, the portion of fixture 10 housing power regulating devices (see the lower housing portion of FIG. 2 containing panel 13) may be thermally isolated from the portion of fixture 10 housing subassembly 20 (see the upper housing portion of FIG. 2 containing lens 15), or may be remotely located (e.g., in a separate enclosure affixed to pole 11). This may be done for a variety of reasons; particularly, to prevent heat emitted from LEDs 22 from damaging said devices, or to allow easy access to said devices for servicing or otherwise.

What is claimed is:

1. An LED lighting fixture comprising:
a. a lighting fixture housing having a body with an outer surface, an internal space, and an opening from the outer surface to the internal space;
b. a mounting surface within the internal space of the lighting fixture housing;
c. a plurality of LEDs mounted to the mounting surface;
d. a plurality of optical elements each having a base, each optical element adapted to modify the light output of an associated LED when the base abuts at least a portion of the mounting surface around the LED; and
e. a positioning device adapted to positionally affix the optical elements relative the LEDs.

2. The LED lighting fixture of claim 1 wherein the positioning device includes a plurality of apertures, and wherein the light output of the LEDs is transmitted through the apertures and out the opening of the lighting fixture housing.

3. The LED lighting fixture of claim 1 wherein one or more optical elements is of selectable or adjustable design or orientation.

4. The LED lighting fixture of claim 3 wherein the design or orientation is selected or adjusted, at least in part, based on the shape of the lighting fixture housing.

5. The LED lighting fixture of claim 3 wherein the design or orientation is selected or adjusted, at least in part, based on the angle of one or more optical elements relative the lighting fixture housing.

6. The LED lighting fixture of claim 1 further comprising:
a. a mounting structure; and
b. an adjustable mounting knuckle adapted to mount the LED lighting fixture to the mounting structure.

7. The LED lighting fixture of claim 6 wherein one or more optical elements is of selectable or adjustable design or orientation, and wherein the design or orientation is selected or adjusted, at least in part, based on the angle of the LED lighting fixture relative the mounting structure.

8. The LED lighting fixture of claim 3 further comprising indicia or structure to indicate optical element orientation.

9. The LED lighting fixture of claim 7 further comprising indicia or structure to indicate optical element orientation.

10. A method of illuminating a target area to a desired illumination level while avoiding undesirable lighting effects comprising:
a. defining a desired illumination level for a target area;
b. designing a lighting system layout including one or more of the LED lighting fixtures of claim 3; and
c. selecting or adjusting the design or orientation of at least one optical element so to satisfy the desired illumination level based, at least in part, on avoiding said undesirable lighting effects.

11. The method of claim 10 wherein the undesirable lighting effects comprise one or more of:
a. harsh spots;
b. shadows;
c. glare.

12. The method of claim 11 wherein the selecting or adjusting the design or orientation of at least one optical element is based, at least in part, on one or more of:
a. shape of the lighting fixture housing;
b. orientation of one optical element relative another;
c. orientation of an optical element relative the lighting fixture housing.

13. A lighting fixture comprising:
a. a housing;
b. a plurality of LEDs mounted at spaced-apart position locations on a board positioned in the housing, each LED having an aiming axis extending outwardly from the board;
c. a removable locating member mounted at each LED;
d. cooperating structure on the locating member and the board to maintain the locating member in a fixed position along the board and relative to the aiming axis of the LED;
e. a receiver on the locating member;
f. a removable optical element positioned in the receiver of the locating member;
g. complementary structure on the receiver and the optical element to maintain the optical element in a fixed position along the board and relative the aiming axis of the LED but allow rotation of the optical element around the aiming axis of the LED;
h. a removable retaining plate installable to the board; and
i. restraining structure on the retaining plate and the optical elements to restrain all the optical elements and locating members in place along the aiming axes of their corresponding LEDs but allow light from each LED and optical member to pass out of the retaining plate and the housing;
j. so that each optical element for each LED can be independently selected and rotationally adjusted relative to its LED with automatic location relative the aiming axis of the LED by the locating member to allow customization of an overall composite light output from all the LEDs and optical elements of the fixture.

14. The lighting fixture of claim 13 wherein the optical element comprises a reflector that modifies light output of its LED relative the aiming axis of the LED.

15. The lighting fixture of claim 13 further comprising:
a. a removable visor mounted at each optical member;
b. aligned structure on the visor, optical element, and locating member to maintain the visor in a fixed position along the board and relative the aiming axis of the LED but allow rotation of the visor around the aiming axis of the LED.

16. The lighting fixture of claim 15 wherein:
a. the cooperating structure comprises at least one peg depending from a side of the locating member and a hole in the board;
b. the complementary structure comprises a raised circular lip on an opposite side of the locating member;
c. the aligned structure comprises surfaces on the visor, optical element and locating member; and
d. the restraining structure comprising surfaces to clamp the visor, optical element, and locating member for each LED to the board.

17. The lighting fixture of claim 16 wherein the locating member allows 360 degree rotation of the optical element and the visor around the aiming axis of the LED.

18. A method of lighting a target area comprising:
a. selecting a plurality of LEDs, each having a light output distribution pattern relative an aiming axis;
b. mounting the plurality of LEDs on a board at spaced-apart position locations wherein the aiming axes of the LEDs extend generally outwardly of the board;
c. stacking along the aiming axis of each LED (i) a removable locating member to the board in a fixed relation to the aiming axis and (ii) a removable optical element to the locating member with 360 degree adjustment around the aiming axis;
d. rotating each optical element to a desired position to modify the light output distribution pattern of each LED;
e. clamping the stacked locating members and optical elements at each LED in place after rotational positioning of the optical elements in their locating members;
f. positioning the board in a lighting fixture;
g. positioning the fixture relative the target area; and
h. operating the fixture to project a composite light output to the target area from the modified light output distribution patterns from the clamped and stacked combinations of optical elements relative to their LEDs.

19. The method of claim 18 further comprising stacking a visor along the aiming axis of at least some of the LEDs.

20. The method of claim 18 further comprising assembling and operating a plurality of the fixtures relative to the target area.
